(19) United States
(12) Patent Application Publication
(10) Pub. No.: US 2007/0156579 A1
(43) Pub. Date: Jul. 5, 2007

(54) System and method of reducing or eliminating change in cash transaction by crediting at least part of change to buyer's account over electronic medium

(75) Inventor: Cameron J. Manesh, Rockville, MD (US)

Correspondence Address: STEIN, MCEWEN & BUI, LLP, 1400 EYE STREET, NW, SUITE 300, WASHINGTON, DC, 20005, US

(73) Assignee: UBEQUITY, LLC, Rockville, MD (US)

(21) Appl. No.: 11/325,502

(22) Filed: Jan. 5, 2006

(51) Int. Cl. G06Q 40/00

(52) U.S. Cl. 705/39

(57) ABSTRACT

A method of reducing or eliminating change in a cash transaction includes receiving a cash payment for an article or a service from a buyer; and crediting at least part of change from the cash payment due the buyer to an account of the buyer over an electronic medium. A system of reducing or eliminating change in a cash transaction includes a merchant terminal that processes a cash payment received from a buyer for an article or a service; a communication device that sends a message over an electronic medium specifying that at least part of change from the cash payment is to be credited to an account of the buyer; and a change credit apparatus that credits the at least part of the change to the buyer's account.

### BACKGROUND OF THE INVENTION

1. Field of the Invention

The present invention relates to the field of sales transactions, and more particularly to a system and method of reducing or eliminating change in a cash transaction by crediting part or all of the change to a buyer's account over an electronic medium.

2. Description of the Related Art

In today's world, buyers pay for articles and services they buy from sellers using money, such as, for example, cash, and money substitutes, such as, for example, checks, credit cards, debit cards, stored-value cards, and electronic money.

As used in this application, “buyer” or “customer” means any person or entity that buys an article or a service; “seller” or “merchant” means any person or entity that sells an article or service, and includes any person or any entity acting on behalf of the seller or merchant, such as, for example, a cashier; “buy” means any method of acquiring a whole or part interest in something from a seller for a charge, including buying, leasing, and renting; “sell” means any method of transferring a whole or part interest in something to a buyer for a charge, including selling, leasing, and renting; and “article” means any tangible thing, such as, for example, a pack of chewing gum, or any intangible thing, such as, for example, a music file download.

Cash is money in the form of currency, which includes paper money and coins. Coins were first introduced in Asia Minor during the seventh century B.C., and were the only type of currency for over a thousand years, until paper money was introduced in China in the seventh century A.D. The first paper money in Europe was issued in Sweden in 1660.

Today most, if not all, countries of the world issue both paper money and coins. For example, the United States issues paper money in denominations of $100, $50, $20, $10, $5, $2, and $1, and coins in denominations of $1, 50¢, 25¢, 10¢, 5¢, and 1¢. The member states of the European Union issue paper money in denominations of [symbol] 500, [symbol] 200, [symbol] 100, [symbol] 50, [symbol] 20, [symbol] 10, and [symbol] 5, and coins in denominations of [symbol] 2, [symbol] 1, 50c, 20c, 10c, 5c, 2c, and 1c.

However, there are many disadvantages to using cash. A buyer must carry cash with him in order to use the cash to pay for a transaction, and accordingly the cash is susceptible to loss and theft. If the buyer has not brought enough cash with him to pay for a particular transaction, he cannot complete the transaction until he obtains more cash. Even if the buyer attempts to minimize the possibility of loss and theft by keeping his cash in his home until he needs to use it, the cash is still susceptible to loss, theft, and destruction in his home.

In light of the disadvantages of using cash, in recent years more and more buyers, particularly in the United States and other developed countries, have been switching from cash to money substitutes as their preferred method of paying for transactions. To accommodate this switch in payment preference, many electronic payment systems for processing transactions paid for with money substitutes have been developed. A recent estimate is that credit cards and debit cards are used to pay for 43% of all purchases in the U.S.

However, even in developed countries, there are still many sales outlets that accept only cash, and many other outlets in which cash transactions predominate. As a general rule, the smaller a transaction is, the more likely it will be paid for in cash.

One example of sales outlets in which most or all of the transactions are paid for in cash are fast-food outlets such as, for example, McDonalds, Burger King, Wendy's, In-N-Out Burger, White Castle, etc. The total value of transactions in these outlets in the United States was $134 billion in a recent year. A recent estimate is that 86% of the transactions in these outlets are under $25.00 with the mean being about $12.00, and more than 90% of those transactions are paid for in cash.

Furthermore, in developing countries, far fewer buyers are able to use money substitutes to pay for transactions, and an overwhelming majority of buyers in these countries pay for all of their transactions in cash. In fact, a recent estimate is that 90% of all of the transactions in the world are paid for in cash.

A recent estimate is that cash transactions will total $1.2 trillion worldwide in 2005. Thus, it appears that cash transactions will continue to make up a substantial portion of sales transactions worldwide in the foreseeable future.

One particularly troublesome aspect of paying for transactions in cash is coins. A recent estimate is that there is about $8 billion in coins in circulation in the U.S. turning over about 18 times a year. It has been estimated that only 3% of the coins in circulation are needed to maintain the economy on a daily basis. Unlike paper money which is very susceptible to wear, coins are extremely durable and can remain in circulation for decades. On occasion, a buyer will receive a coin in change that is more than 50 years old. Nevertheless, in Fiscal Year 2004, the U.S. Mint shipped 12.1574 billion coins totaling $993.5 million to the Federal Reserve Banks to replenish inventory and fulfill commercial demand. These coins included 7.13 billion pennies ($71.3 million), 1.392 billion nickels ($69.6 million), 2.569 billion dimes ($256.9 million), 1.0276 billion quarters ($560.4 million), 7 million half dollars ($3.5 million), and 31.8 million dollars ($31.8 million). The billions of coins in circulation over and above what is needed to maintain the economy on a daily basis represent a vast amount of unused equity that could be earning a return if there were a way to capture part of it and invest it.

Coins are inconvenient for sellers to use because they are time-consuming to count and roll. Also, sellers must constantly replenish their coin supply because most buyers will pay for cash transactions in paper money only, so sellers almost always give out more coins in change than they take in, particularly since most cash transactions are not for even dollar amounts. If a buyer does pay for part of a cash transaction in coins, this invariably slows down the transaction because the cashier has to wait for the buyer to dig out his change and sort through it. While this may only take a few seconds, it can add up to a significant amount of time over the course of a day for a seller who has a high volume of buyers, such as, for example, a fast-food restaurant. Furthermore, some banks charge sellers a fee for each roll of coins, for example, $0.15 per roll. While this may seem like a small amount per roll, it can add up to a large amount for sellers who use a lot of coins.

Coins are also inconvenient for buyers to use. As a result, many buyers dislike using coins, and try to avoid carrying them. Even if buyers do happen to have coins with them, very few buyers will actually dig into their pockets or purses for coins to use in paying for a cash transaction. Also, even if a buyer avoids carrying coins with him, most cash transactions will result in the buyer receiving change, which almost always includes coins. Coins are particularly susceptible to loss because of their small size. Furthermore, buyers tend to be careless with coins because of their small value, which further increases their susceptibility to loss. Some buyers will even throw coins away rather than carry them.

Because of their dislike for coins, many buyers will toss their coins into a jar or other storage container when they come home at the end of the day, intending some day to take the coins to a bank to exchange them for paper money or to deposit them in an account. However, most banks will not accept more than a few loose coins, so before a buyer can take his coins to the bank, he must sort, count, and roll them, a tedious process which takes a long time. When faced with this task, many buyers decide to put it off, so more coins accumulate, which makes the task even harder, which makes the buyers want to put it off even more, and so on in a vicious cycle. It has been estimated that there is more than $7.7 billion in coins being hoarded in buyers' homes in the U.S., a vast amount of unused equity that could be earning a return if there were an easy way for people to turn their hoarded coins into cash and invest it.

In an effort to make it easier for people to turn their hoarded coins into cash, in 1991, Coinstar, Inc., of Bellevue, Wash., which has a website at www.coinstar.com installed self-service coin counting machines in the San Francisco Bay area. These machines are typically installed in grocery stores. To use one of these machines, a customer dumps his coins into the machine which sorts and counts them at up to 600 coins per minute and prints out a voucher for the value of the coins less a processing fee. The customer then exchanges the voucher for cash or groceries at the checkout. Coinstar reimburses the grocery store for the amount of the voucher. Coinstar's processing fee is 8.9% in the United States, 9.8% in Canada, and 7.9% in the United Kingdom, which might seem high, but customers have been more than willing to pay it. This is evidenced by the fact that by 2002, Coinstar had more than 10,000 machines in operation, and by 2005, had processed more than $10 billion in coins in 290 million transactions, an average of $34.48 per transaction. Coinstar's fee for this average transaction was only about $3.07, but when multiplied by the 290 million transactions comes out to about $890 million. Coinstar's success clearly indicates that people are willing to pay a substantial fee to turn their hoarded coins into cash.

Although Coinstar's system has reduced or solved some of the problems associated with coins, such as, for example, the problem of having to sort, count, and roll coins before they can be exchanged for paper money or deposited in an account, and the difficulty of turning hoarded coins into cash, it has not solved the many other problems associated with coins, such as, for example, the inconvenience to sellers and buyers caused by having to use coins as change in cash transactions, the cost to sellers for coins to use as change, the susceptibility of coins to loss and hoarding, and the inability to capture any of the vast amount of unused equity in the billions of coins in circulation that are over and above what is needed to maintain the economy on a daily basis.

Also, Coinstar's system has created new problems of its own. For example, a person who wants to use one of Coinstar's machines must find a machine and take his coins to it, which can be inconvenient, particularly if the machine is far away from his house or he has a lot of coins. And although Coinstar has over 10,000 machines in operation, there are still many areas where there is no machine within a reasonable driving distance. Accordingly, it would be desirable to have some way of solving these new problems created by Coinstar's system, as well as solving the problems associated with coins that are not solved by Coinstar's system.

Furthermore, the fact that Coinstar's average transaction is $34.48 indicates that people will wait until they accumulate a sizeable number of coins before taking their coins to a Coinstar machine. While the coins are accumulating, they represent unused equity that could be earning a return if it were invested. It has been estimated that about $140 billion in coins received in change is handled by buyers each year, which is about $600 per buyer per year, or about $11.50 per buyer per week. If the buyer were to deposit this $11.50 in coins each week in an account earning 7%, after 30 years his investment would be worth about $61,000, which is about $43,000 more than the $18,000 he would have if he had simply kept the coins in a jar. However, almost no buyer has the discipline required to save his coins each day and deposit them each week in an account, week after week, for 30 years.

Bank of America of Charlotte, N.C., which has a website at www.bankofamerica.com recently introduced a program called “Keep the Change” designed to make it easier for a buyer to increase the balance in his savings account. Each time a buyer pays for a transaction with his Bank of America Visa debit card, the amount of the transaction is rounded up to the nearest dollar and the difference is transferred from the buyer's checking account to his savings account. For example, if the amount of a transaction is $4.32, $5.00 is deducted from the buyer's checking account, of which $4.32 is used to pay for the transaction and $0.68 is deposited in his savings account. Thus, every time the buyer pays for a transaction with his Bank of America Visa debit card, the balance in his savings account increases.

Although Bank of America's “Keep the Change” program makes it easier for a buyer to increase the balance in his savings account, the program does not actually increase the total amount of money the buyer has on deposit. All the program does is transfer money from the buyer's checking account to the buyer's savings account where the money presumably is less likely to be spent and will earn a greater return than if it were to remain in the buyer's checking account. Thus, this program cannot solve the new problems created by Coinstar's system as discussed above or the problems associated with coins that are not solved by Coinstar's system as discussed above, and cannot automatically deposit an amount a buyer would receive as coins in change each time he pays for a transaction in cash.

Accordingly, it would be desirable for a buyer to have some way of easily increasing the total amount of money he has on deposit at a financial institution by automatically depositing the amount he would receive as coins in change each time he pays for a transaction in cash.

### SUMMARY OF THE INVENTION

Various aspects and example embodiments of the present invention advantageously provide a system and method of efficiently reducing or eliminating change in cash transactions.

Additional aspects and/or advantages of the present invention will be set forth in the description which follows and, in part, will be obvious from the description, or may be learned by practice of the invention.

One aspect of the present invention is reducing change in cash transactions by crediting part of the change to a buyer's account over an electronic medium. The amount of change that is credited may be an amount of change that would be paid in coins, thereby eliminating coins as change in cash transactions. The amount of change that is credited may be an amount of change that would be paid in paper money, thereby eliminating paper money as change in cash transactions. The amount of change that is credited may be an arbitrary portion of change specified by the buyer, thereby reducing change in cash transactions.

Another aspect of the present invention is eliminating change in cash transactions by crediting an entire amount of the change to a buyer's account over an electronic medium.

In accordance with one aspect of the present invention, a method of reducing or eliminating change in a cash transaction includes receiving a cash payment for an article or a service from a buyer; and crediting at least part of change from the cash payment due the buyer to an account of the buyer over an electronic medium.

The crediting of the at least part of the change may include crediting a maximum part of the change that can only be paid in coin to the buyer's account over the electronic medium.

The crediting of the at least part of the change may include crediting a maximum part of the change that can be paid only in paper money to the buyer's account over the electronic medium.

The crediting of the at least part of the change may include crediting an entire amount of the change to the buyer's account over the electronic medium.

The crediting of the at least part of the change may include asking the buyer to specify a part of the change the buyer wants credited to the buyer's account; and crediting the part of the change specified by the buyer to the buyer's account over the electronic medium.

The buyer's account may be a savings account, a checking account, a credit card bill, a cell phone bill, or a prepaid account, such as a prepaid cell phone account.

The buyer's account may be a virtual account maintained by a third party for the benefit of the buyer. The virtual account may be held in an account belonging to the third party. The third party may operate a system which enables the at least part of the change to be credited to the buyer's account over the electronic medium.

The electronic medium may include at least a wireless telephone network. The crediting of the at least part of the change may include sending over the wireless telephone network an SMS text message specifying a part of the change to be credited to the buyer's account.

A buyer ID number may be received from the buyer via an RFID (radio-frequency identification) device, an infrared device, a proximity device, a smart card, or a key fob. The crediting of the at least part of the change may include identifying the buyer's account based on the buyer ID number.

In accordance with another aspect of the present invention, a system of reducing or eliminating change in a cash transaction includes a merchant terminal that processes a cash payment received from a buyer for an article or a service; a communication device that sends a message over an electronic medium specifying that at least part of change from the cash payment is to be credited to an account of the buyer; and a change credit apparatus that credits the at least part of the change to the buyer's account.

The change credit apparatus may include a change credit module that receives the message from the communication device and outputs a change credit amount equal to a part of the change that is to be credited to the buyer's account, a type of the buyer's account, and account ID data identifying the buyer's account; an electronic payment module that receives the change credit amount, the type of the buyer's account, and the account ID data from the change credit module and outputs electronic payment instructions to credit the change credit amount to the buyer's account; and an electronic payment system that receives the electronic payment instructions from the electronic payment module and credits the change credit amount to the buyer's account.

The message may specify that a maximum part of the change that can only be paid in coin is to be credited to the buyer's account.

The message may specify that a maximum part of the change that can be paid only in paper money is to be credited to the buyer's account.

The message may specify that an entire amount of the change is to be credited to the buyer's account.

The buyer may specify a part of the change the buyer wants credited to the buyer's account, and the message may specify that the part of the change specified by the buyer is to be credited to the buyer's account.

The buyer's account may be a savings account, a checking account, a credit card bill, a cell phone bill, or a prepaid account, such as a prepaid cell phone account.

The buyer's account may be a virtual account maintained by a third party for the benefit of the buyer. The virtual account may be held in an account belonging to the third party. The third party may operate at least part of the change credit apparatus.

The electronic medium may include at least a wireless telephone network. The communication device may send the message as an SMS text message over the wireless telephone network.

The merchant terminal or the communication device may receive a buyer ID number from an RFID (radio-frequency identification) device, an infrared device, a proximity device, a smart card, or a key fob. The change credit apparatus may identify the buyer's account based on the buyer ID number.

In addition to the aspects example embodiments as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 shows a system for reducing or eliminating change in a cash transaction according to one aspect of the present invention;

FIG. 2 shows a data structure of the customer Ubequity account data shown in FIG. 1;

FIG. 3 shows a data structure of the merchant Ubequity account data shown in FIG. 1;

FIG. 4 shows a data structure of the Ubequity operator Ubequity account data shown in FIG. 1;

FIG. 5 shows a data structure of the Ubequity transaction data shown in FIG. 1; and

FIGS. 6A, 6B, and 6C show a method for reducing or eliminating change in a cash transaction according to another aspect of the present invention using the system shown in FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The inventor of the present invention has developed the “Ubequity system” in part to practice the present invention. The term “Ubequity” has been coined by the inventor of the present invention, and means “ubiquitous equity,” referring, among other things, to the ubiquitous unused equity in coins both in circulation and hoarded away in jars, piggy banks, drawers, and other places throughout the world. The present invention was made in part to make it possible to capture some of this unused equity so it can be put to use by eliminating coins as change in cash transactions by crediting an amount of change that is payable in coins to a buyer's account over an electronic medium.

However, the present invention is not limited to crediting an amount of change that is payable in coins to a buyer's account, but also includes crediting an amount of change that is payable in bills to a buyer's account, crediting an arbitrary portion of change specified by a buyer to a buyer's account, and crediting an entire amount of change to a buyer's account. That is, the present invention includes crediting at least part of change in a cash transaction to a buyer's account.

In the description which follows, examples are given of various aspects of the present invention merely for the purpose of helping to explain the present invention. However, it is to be understood that the invention is in no way limited to these examples, but includes all other suitable alternatives, variations, modifications, and implementations.

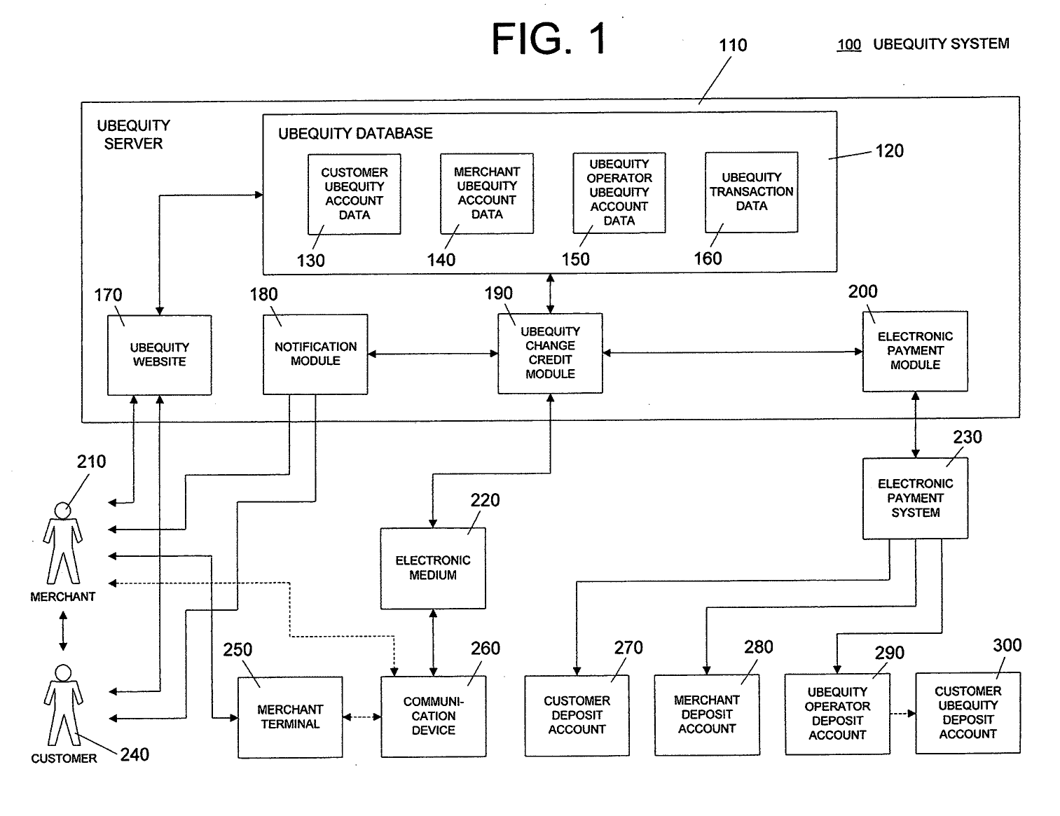

FIG. 1 shows an embodiment of the Ubequity system 100 according to the present invention. The Ubequity system 100 includes a Ubequity server 110 which hosts a Ubequity database 120, a Ubequity website 170, a Ubequity change credit module 190, an electronic payment module 200, and a notification module 180. The Ubequity server 110 may host multiple electronic payment modules 200 if electronic payments are to be made through multiple electronic payment systems as described below.

The Ubequity server 110 includes all communications hardware and software necessary to enable the Ubequity website 170, the Ubequity change credit module 190, the electronic payment module 200, and the notification module 180 to communicate with the outside, but for the sake of simplicity, this communications hardware and software is not shown in FIG. 1. Accordingly, the connections between the outside and the Ubequity website 170, the Ubequity change credit module 190, the electronic payment module 200, and the notification module 180 as shown in FIG. 1 are to be understood as including the necessary communications hardware and software included in the Ubequity server 110.

Although it is described as a server, the Ubequity server 110 may be any computer or data processing apparatus capable of hosting the Ubequity database 120, the Ubequity website 170, the Ubequity change credit module 190, the electronic payment module 200, and the notification module 180 regardless of whether the computer or data processing apparatus is described as a “server” by its manufacturer.

The Ubequity database 120, the Ubequity website 170, the Ubequity change credit module 190, the electronic payment module 200, and the notification module 180 are software applications which may be implemented using any suitable software.

A merchant 210 makes available articles and/or services for purchase by a customer 240, and sells the articles and/or services to the customer 240 in sales transactions conducted using a merchant terminal 250.

The term “merchant terminal” as used in this application means all equipment necessary to conduct sales transactions and process payments made by the customer 240. For example, the merchant terminal 250 may be a cash register or a POS (point-of-sale) terminal. It may also be a virtual terminal running on any of the following: a server, a desktop computer, a laptop computer, a PDA (personal digital assistant), a WAP (wireless application protocol) phone, a cell phone, or any other suitable data processing apparatus. The virtual terminal may be web-based. The cash register, POS terminal, or virtual terminal may have the capability of processing payments made with money substitutes, such as, for example, checks, credit cards, debit cards, stored-value cards, and electronic money, or the merchant terminal 250 may include a separate payment processing device for processing such payments, such as, for example, a credit card terminal or other device for processing such payments.

The merchant terminal has associated with it a communication device 260 which is used by the merchant 210, either directly or via the merchant terminal 250, to send instructions to the Ubequity change credit module 190 via an electronic medium 220 to initiate a process of crediting at least part of change in a cash transaction to an account of the customer 240. The dashed line between the merchant 210 and the communication device 260 indicates a case where the merchant 210 uses the communication device 260 directly, and the dashed line between the merchant terminal 250 and the communication device 260 indicates a case where the merchant 240 uses the communication device 260 via the merchant terminal 250.

The term “communication device” as used in this application means any device which can communicate with the Ubequity change credit module 190 over the electronic medium 220, such as, for example, a land-based telephone, a cell phone, a credit card terminal, a POS terminal, a virtual terminal, a desktop computer, a laptop computer, a PDA, a WAP phone, or any other suitable communication device.

The communication device 260 may be part of the merchant terminal 250. For example, if the merchant terminal 250 includes a cash register, a POS terminal, a virtual terminal, or a credit card terminal and this device can communicate with the Ubequity change credit module 190 over the electronic medium 220, then the cash register, the POS terminal, or the virtual terminal may be used as the communication device 260. However, the communication device 260 is shown as a separate device in FIG. 1 to better explain the present invention because its function in the present invention is a new function which was developed as part of the present invention by the inventor of the present invention.

The term “electronic medium” as used in this application means any electronic medium over which the communication device 260 can communicate with the Ubequity change credit module 190, such as, for example, a wired telephone network, a wireless telephone network, the Internet, an extranet, a WAN (wide-area network) a MAN (metropolitan area network), a VPN (virtual private network), a leased line, a wired non-telephone network, or a wireless non-telephone network, or any combination of two or more of these electronic media.

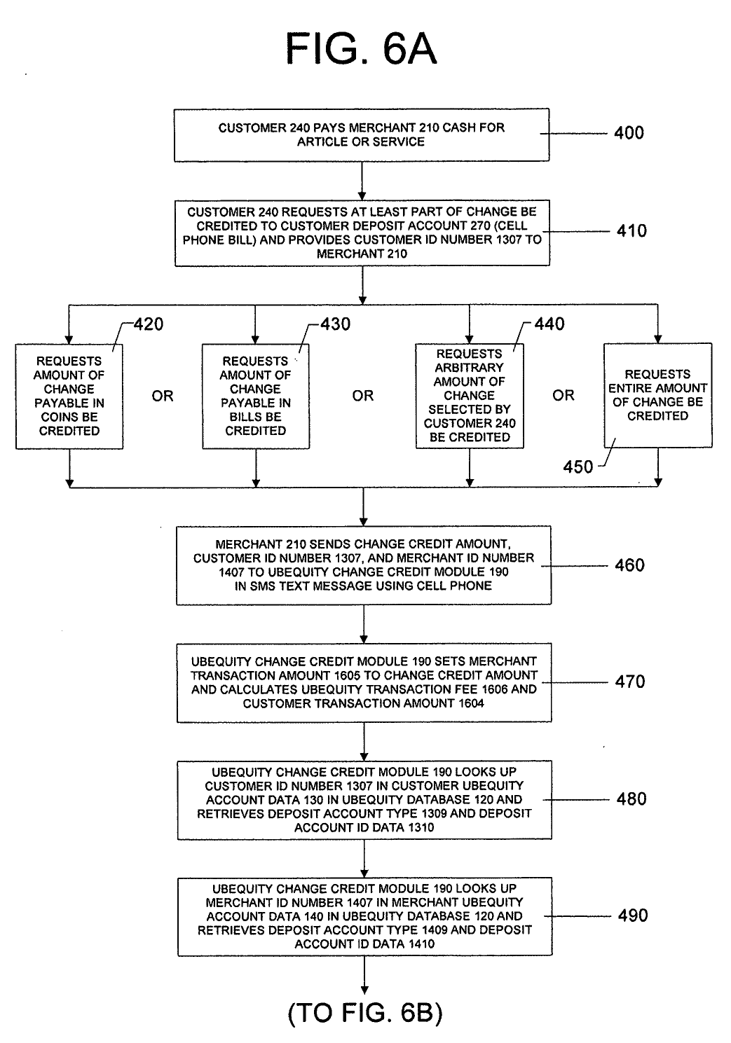

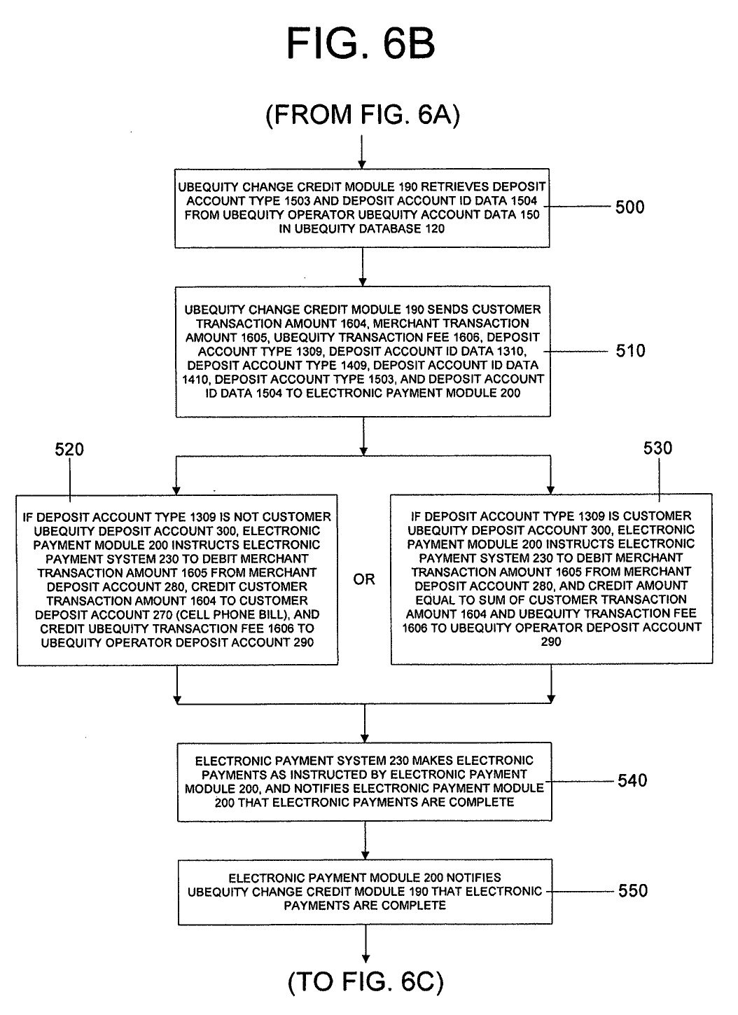

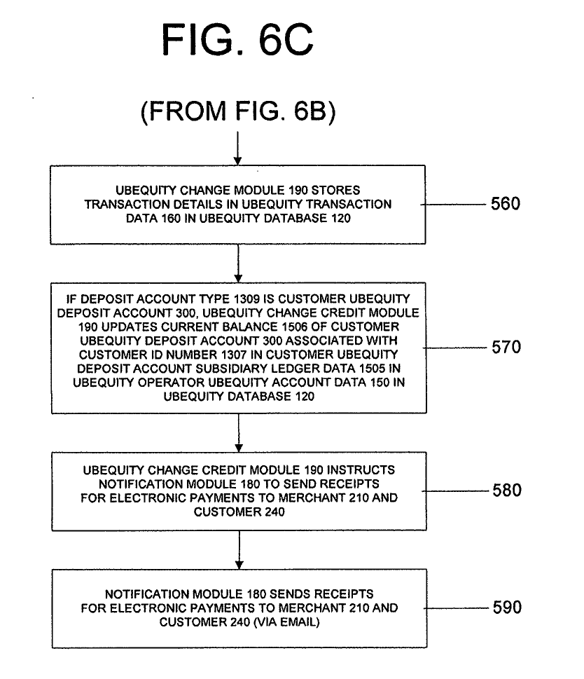

The Ubequity change credit module 190 sends electronic payment instructions to the electronic payment module 200 based on data retrieved from the Ubequity database 120 in response to the instructions received from the communication device 260 via the electronic medium 220, receives notification from the electronic payment module 200 that the electronic payment is complete, and instructs the notification module 180 to send receipts for the electronic payment to the merchant 210 and the customer 240. This will be explained in greater detail below in connection with FIGS. 6A-6B.

The notification module 180 sends receipts for the electronic payment to the merchant 210 and the customer 240 as instructed by the Ubequity change credit module 190. The notification module 180 may send the receipts via email, or by any other suitable method.

The electronic payment module 200 sends electronic payment instructions to an electronic payment system 230 in response to the electronic payment instructions received from the Ubequity change credit module 190, stores transaction details in the Ubequity database 120, and notifies the Ubequity change credit module 190 when the electronic payment is complete. This will be explained in greater detail below in connection with FIGS. 6A-6B. The electronic payment module 200 is compatible with the electronic payment system 230. If electronic payments are to be made through multiple electronic payment systems 230, the Ubequity server 110 hosts multiple electronic payment modules 200 each compatible with a respective one of the multiple electronic payment systems 230.

The electronic payment system 230 is capable of electronically transferring funds to and from a customer deposit account 270, a merchant deposit account 280, and a Ubequity operator deposit account 290. That is, the electronic payment system 230 is capable of issuing electronic debits and credits to the customer deposit account 270, the merchant deposit account 280, and the Ubequity operator deposit account 290. The electronic payment system 230 is also capable of notifying the electronic payment module 200 when the electronic payment is complete. The Ubequity operator deposit account 290 belongs to the operator of the Ubequity system 100, hereinafter referred to as the “Ubequity operator”. For simplicity, FIG. 1 shows only one customer deposit account 270 and one merchant deposit account 280, but in reality there will be one customer account 270 for each customer 240 using the Ubequity system 100 and one merchant deposit account 280 for each merchant 210 using the Ubequity system 100.

The terms “customer deposit account”, “merchant deposit account”, and “Ubequity operator deposit account” as used in this application mean any account which can accept electronic debits and credits, such as, for example, a checking account or a savings account at a bank or other financial institution, a credit card account, a cell phone bill, or a prepaid account, such as a prepaid cell phone account. The term “customer deposit account” also includes a customer Ubequity deposit account which will be described in detail below.

The Ubequity database 120 includes customer Ubequity account data 130, merchant Ubequity account data 140, Ubequity operator Ubequity account data 150, and Ubequity transaction data 160, and may include any other data useful in operating the Ubequity system 100.

The term “Ubequity account” as used in this application means an individual account established by customers 240, merchants 210, and the Ubequity operator to enable them to use the Ubequity system 100.

Each customer 240 who wants to use the Ubequity system 100 accesses the Ubequity website 170, selects an option to create a customer Ubequity account, and enters the customer Ubequity account data 130 which is stored in the Ubequity database 120.

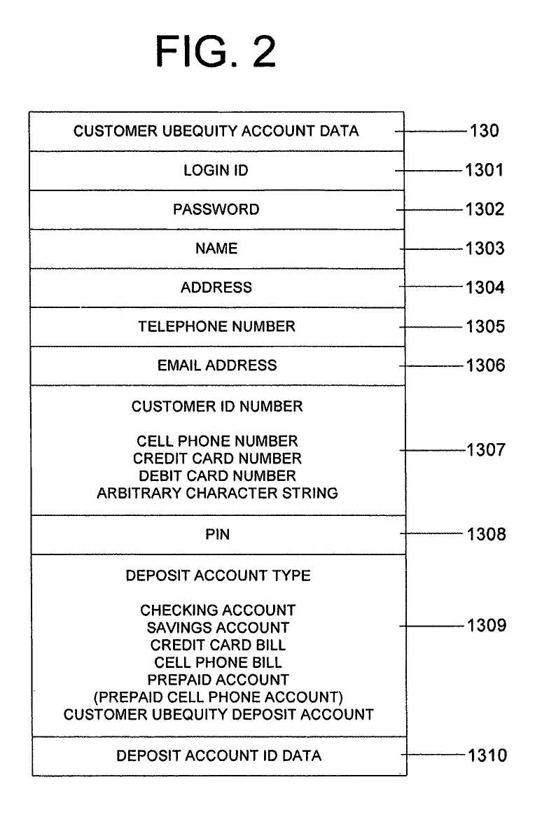

FIG. 2 shows an example of the customer Ubequity account data 130, which may include at least a login ID 1301, a password 1302, the customer's name 1303, his address 1304, his telephone number 1305, his email address 1306, a customer ID number 1307 he will use to identify himself for transactions on the Ubequity system 100, a PIN (personal identification number) 1308 that may be used to authenticate certain types of transactions on the Ubequity system 100, a deposit account type 1309 of the customer deposit account 270 he will use for transactions on the Ubequity system 100, and customer deposit account ID data 1310 of the customer deposit account 270 he will use for transactions on the Ubequity system 100.

However, some customers 240 who want to use the Ubequity system 100 may not have the ability to access the Ubequity website 170 because, for example, they do not have a computer, or they have a computer but do not have an Internet connection. To accommodate such customers 240, the Ubequity operator may offer a service where such a customer 240 can call a telephone number, which may be a toll-free telephone number, and a Ubequity customer service agent will access the Ubequity website 170 and create an account and enter the customer Ubequity account data 130 for the customer 240.

The customer ID number 1307 may be, for example, a cell phone number of the customer 240, a credit card number of the customer 240, a debit card number of the customer 240, an arbitrary character string which uniquely identifies the customer 240, or any other number which uniquely identifies the customer 240.

The deposit account type 1309 of the customer deposit account 270 may be, for example, a checking account or a savings account at a bank or other financial institution, a credit card account, a cell phone bill, a prepaid account, such as a prepaid cell phone account, or a customer Ubequity deposit account 300.

A customer Ubequity deposit account 300 is conceptually a virtual customer deposit account 270, and is an account maintained by the Ubequity operator for the benefit of a customer 240 who does not have any other account he can use for transactions on the Ubequity system 100, or for a customer 240 who has such an account but chooses not to use it for transactions on the Ubequity system 100. A recent estimate is that at least 25 million wage earners in the U.S. do not have a bank account.

The funds on deposit in the customer Ubequity deposit account 300 are actually held in the Ubequity operator deposit account 290 together with funds on deposit in customer Ubequity deposit accounts 300 belonging to other customers 240 as well as funds belonging to the Ubequity operator. This relationship is indicated by the dashed line between the Ubequity operator deposit account 290 and the customer Ubequity deposit account 3000 in FIG. 1. Preferably, the customer Ubequity deposit account 300 accepts only electronic credits, because an electronic debit would in effect be a loan from the Ubequity operator to the customer 240.

The deposit account ID data 1310 is data that identifies the customer deposit account 270 in sufficient detail to enable the electronic payment module 200 to instruct the electronic payment system 230 to issue electronic debits and credits to the customer deposit account 270. The deposit account ID data 1310 will depend on the deposit account type 1309 of the customer deposit account 270.

For example, if the customer deposit account 270 is a checking account or a savings account at a bank or other financial institution, the deposit account ID data 1310 may include at least the name of the bank or other financial institution, the ABA routing number of the bank or other financial institution, and the account number of the checking account or the savings account.

If the customer deposit account 270 is a credit card account, the deposit account ID data 1310 may include at least the credit card number and the credit card expiration date.

If the customer deposit account 270 is a cell phone bill or a prepaid cell phone account, the deposit account ID data 1310 may include at least the cell phone number.

If the customer deposit account 270 is the customer Ubequity deposit account 300, the deposit account ID data 1310 may include at least the customer ID number 1307 and a current balance in the customer Ubequity deposit account 300.

Each merchant 210 who wants to use the Ubequity system 100 accesses the Ubequity website 170, selects an option to create a merchant Ubequity account, and enters the merchant Ubequity account data 140 which is stored in the Ubequity database 120.

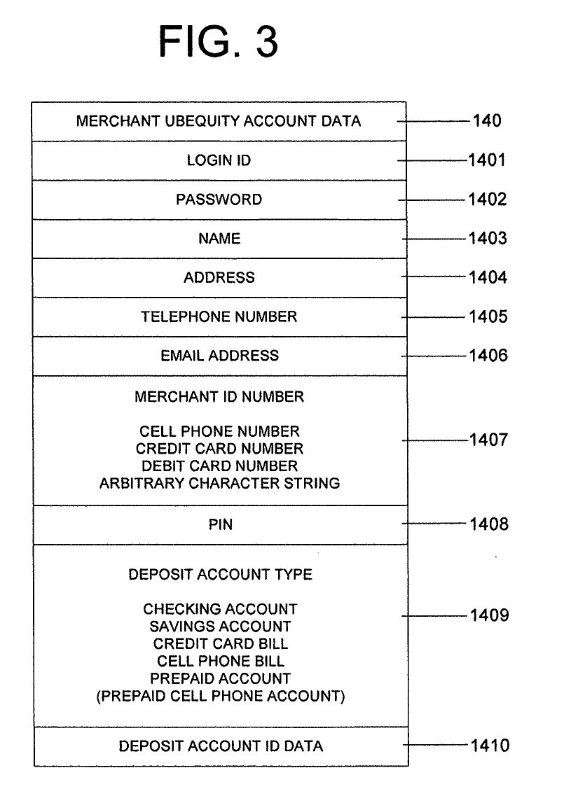

FIG. 3 shows an example of the merchant Ubequity account data 140, which may include at least a login ID 1401, a password 1402, the merchant's name 1403, his address 1404, his telephone number 1405, his email address 1406, a merchant ID number 1407 he will use to identify himself for transactions on the Ubequity system 100, a PIN (personal identification number) 1408 that may be used to authenticate certain types of transactions on the Ubequity system 100, a deposit account type 1409 of the merchant deposit account 280 he will use for transactions on the Ubequity system 100, and merchant deposit account ID data 1410 of the merchant deposit account 280 he will use for transactions on the Ubequity system 100.

The merchant ID number 1407 may be, for example, a cell phone number of the merchant 210, a credit card number of the merchant 210, a debit card number of the merchant 210, an arbitrary character string which uniquely identifies the merchant 210, or any other number which uniquely identifies the merchant 210.

The deposit account type 1409 of the merchant deposit account 280 may be, for example, a checking account or a savings account at a bank or other financial institution, a credit card account, a cell phone bill, or a prepaid account, such as a prepaid cell phone account.

The deposit account ID data 1410 is data that identifies the merchant deposit account 280 in sufficient detail to enable the electronic payment module 200 to instruct the electronic payment system 230 to issue electronic debits and credits to the merchant deposit account 280. The deposit account ID data 1410 will depend on the deposit account type 1409 of the merchant deposit account 280, just like the deposit account ID data 1310 of the customer deposit account 270 as discussed above.

The Ubequity operator accesses the Ubequity website 170, selects an option to create a Ubequity operator account, ands enters the Ubequity operator Ubequity account data 150 which is stored in the Ubequity database 120. This option is not displayed to customers 240 and merchants 210 who access the Ubequity website 170.

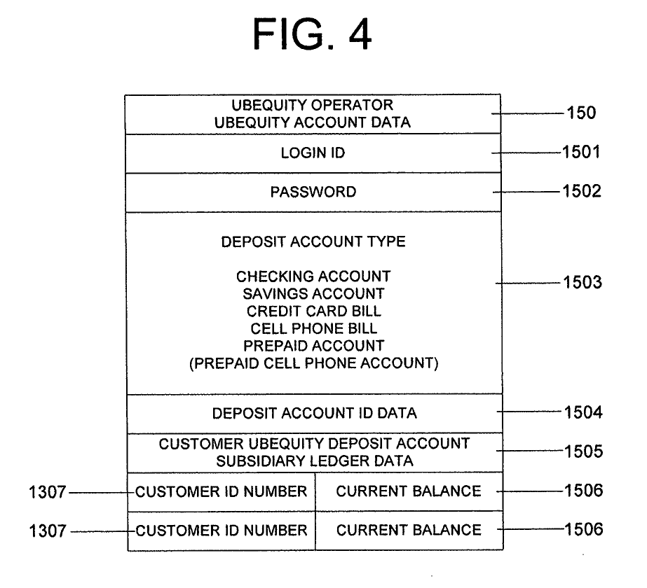

FIG. 4 shows an example of the Ubequity operator Ubequity account data 150, which may include at least a login ID 1501, a password 1502, a deposit account type 1503 of the Ubequity operator deposit account 290 the Ubequity operator will use for transactions on the Ubequity system 100, deposit account ID data 1504 of the Ubequity deposit operator account 290, and customer Ubequity deposit account subsidiary ledger data 1505.

The deposit account type 1503 of the Ubequity operator deposit account 290 may be, for example, a checking account or a savings account at a bank or other financial institution, a credit card account, a cell phone bill, or a prepaid account, such as a prepaid cell phone account.

The deposit account ID data 1504 is data that identifies the Ubequity operator deposit account 290 in sufficient detail to enable the electronic payment module 200 to instruct the electronic payment system 230 to issue electronic debits and credits to the Ubequity operator deposit account 290. The deposit account ID data 1504 will depend on the deposit account type 1503 of the Ubequity operator deposit account 290, just like the deposit account ID data 1310 of the customer deposit account 270 as discussed above.

The customer Ubequity deposit account subsidiary ledger data 1505 may include at least the customer ID number 1307 of each customer 240 who has a customer Ubequity deposit account 300, and a current balance 1506 in that customer's customer Ubequity deposit account 300. FIG. 4 shows an example in which two customers 240 have customer Ubequity deposit accounts 300. However, in reality, there is no limit to the number of customers 240 who may have customer Ubequity deposit accounts 300.

The Ubequity transaction data 160 includes transaction details of transactions conducted on the Ubequity system 100 which are stored in the Ubequity database 120 by the Ubequity change credit module 190.

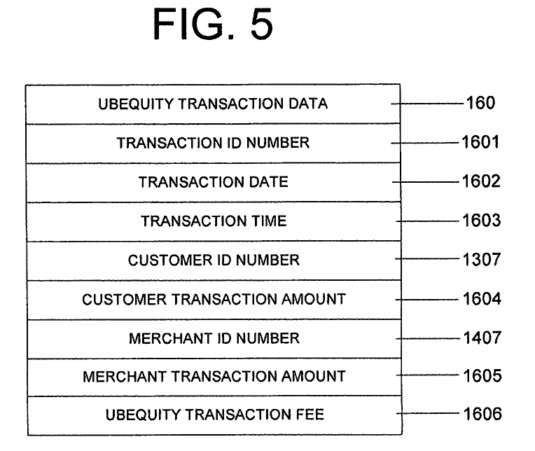

FIG. 5 shows an example of the Ubequity transaction data 160, which may include, for each transaction, at least a transaction ID number 1601, a transaction date 1602 on which the transaction was conducted, a transaction time 1603 at which the transaction was conducted, the customer ID number 1307 of the customer 240 who participated in the transaction, a customer transaction amount 1604 debited from or credited to the customer deposit account 270, with, for example, a positive number indicating a debit and a negative number indicating a credit, the merchant ID number 1407 of the merchant 210 who participated in the transaction, a merchant transaction amount 1605 debited from or credited to the merchant deposit account 280, with, for example, a positive number indicating a debit and a negative number indicating a credit, and a Ubequity transaction fee 1606 debited from or credited to the Ubequity operator deposit account 290, with, for example, a positive number indicating a debit and a negative number indicating a credit. For simplicity, FIG. 5 shows Ubequity transaction data 160 for only one transaction.

The transaction ID number 1601 may be, for example, a sequential number which is increased by one each time a transaction is conducted, or it may be a combination of the transaction date 1602 and the transaction time 1603. For example, if a transaction was conducted on Dec. 15, 2005, at 3:45:20.37 PM, then the transaction ID number 1601 may be 2005121515452037. However, any numbering scheme which produces a unique transaction ID number 1601 for each transaction may be used.

When a Ubequity transaction is a transaction to credit part or all of change in a cash transaction to the customer deposit account 270, the Ubequity transaction fee 1606 may be, for example, 15% of the change to be credited to the customer 240 for an amount in excess of $0.05, and 50% for an amount of $0.05 or less. For example, if $0.92 is to be credited to the customer deposit account 270, a merchant transaction amount 1605 of $0.92 is debited from the merchant deposit account 280, a Ubequity transaction fee 1606 of $0.14 (15% of $0.92) is credited to the Ubequity operator deposit account 290, and a customer transaction amount 1604 of $0.78 is credited to the customer deposit account 270. Thus, for this transaction, the customer transaction amount 1604 would be −$0.78, the merchant transaction amount 1605 would be +$0.92, and the Ubequity transaction fee 1606 would be −$0.14. The Ubequity change credit module 190 calculates the amount of the Ubequity transaction fee 1606 and the customer transaction amount 1604.

As discussed above, FIG. 1 shows the electronic payment system 230. In this application, “electronic payment system” means any system capable of making electronic payments by electronically debiting one account and electronically crediting another account.

One example of an electronic payment system is the Automated Clearing House (ACH) network in the United States, which is a nationwide batch-oriented electronic funds transfer system governed by operating rules which provide for the interbank clearing of electronic payments for participating depository financial institutions. These operating rules are developed by NACHA—The Electronic Payments Association of Reston, Va., which has a website at www.nacha.org. As of 2002, the ACH Network served 20,000 financial institutions, 3.5 million businesses, and 115 million individuals. The ACH Network is commonly used for direct deposit of payroll and government benefits such as, for example, Social Security, direct payment of consumer bills, business-to-business payments, federal tax payments, and e-check and e-commerce payments.

The ACH network works as follows. A receiver authorizes an originator to debit or credit the receiver's account in a receiving depository financial institution (RDFI). The originator sends transaction data to an originating depository financial institution (ODFI) where the originator's account is located. The ODFI verifies the transaction data and sends it to an ACH operator, which sends the transaction data to the RDFI. The RDFI debits or credits the receiver's account in the RDFI and credits or debits the receiver's account in the ODFI. The ACH operator settles the transaction between the RDFI and the ODFI.

There are two national ACH operators. One ACH operator is the Electronic Payments Network (EPN), which is a private processor with approximately 30% of the market at the end of 2002. The other ACH operator is the Federal Reserve Banks. If the ACH operator is the EPN, final settlement is done using the Federal Reserve Banks' National Settlement Service (NSS). If the ACH operator is the Federal Reserve Banks, final settlement is made directly to the RDFI's and ODFI's reserve accounts at a Federal Reserve Bank.

Another example of an electronic payment system is a credit card payment system, such as, for example, the Visa and MasterCard payment systems, each of which consists of a bankcard association which maintains an electronic network and administers the payment system, credit card issuing financial institutions which issue credit cards to buyers, and acquiring financial institutions at which merchants who accept the credit card have merchant accounts. The American Express, Discover, and Diner's Club payment systems are similar, except that the credit card issuing financial institution and the acquiring financial institution are the same financial institution.

A credit card payment system works as follows. A buyer buys an article or service from a merchant using a credit card. The merchant transmits the credit card number, the credit card expiration date, the amount of the purchase, and sometimes the credit card security code through the bankcard association's electronic network to the credit card issuing final institution for authorization. If the credit card issuing financial institution decides to authorize the transaction, it sends authorization back to the merchant through the bankcard association's electronic network. The merchant has the buyer sign for the transaction and completes the transaction.

The merchant sends transaction data for the transaction to the acquiring financial institution where he has his merchant account. The acquiring financial institution sends the transaction data to the bankcard association, which sends the transaction data to the credit card issuing financial institution. To settle the transaction, the credit card issuing financial institution sends the funds owed for the transaction to the bankcard association's settlement financial institution, which sends the funds to the acquiring bank financial institution, which credits the funds to the merchant's merchant account. The settlement process takes place using a separate payment system such as, for example, Fedwire. The credit card issuing bank bills the buyer for the transaction on the buyer's next monthly statement, and the buyer pays for the transaction.

Another example of an electronic payment system is a payment system which enables a customer to pay for an article or service by calling a telephone number on his cell phone. One example of such a system is the parking fee payment system operated by Verrus Mobile Technologies of Vancouver, BC, Canada, which has a website at www.verrus.com. When a driver parks, he calls a telephone number posted in the parking facility and enters the number of the parking space. The call is routed to Verrus, which debits the driver's credit card account and credits the parking facility operator's account via a credit card payment system. A text message warning that the parking time is about to expire is sent to both the driver and the parking facility operator five minutes before the time expires.

The Verrus system uses IBM's Workplace Client Technology, Micro Edition (WCTME), which connects and extends applications from a server to different kinds of devices. This software is packaged so applications developers can easily create applications as part of an end-to-end system. The micro edition is designed for applications on smartphones, telematics devices, as part of an RFID solution, or in industrial automation

Another example of an electronic payment system is a payment system which enables a buyer to pay for an article or service by using his cell phone to initiate a payment process which debits the payment for the article or service from the buyer's bank account or from a prepaid cell phone account the buyer has with his wireless provider, and credits the payment to the merchant's account. SEMOPS of Budapest, Hungary, which has a website at www.semops.com has developed such a payment system. If this payment system is used as the electronic payment system 230 in FIG. 1, it may be modified to be able to credit an amount to the buyer's bank account, prepaid cell phone account, or cell phone bill, and to debit a payment for an article or service from the buyer's cell phone bill.

Many other electronic payment systems are known in the art, and any suitable electronic payment system may be used as the electronic payment system 230 in FIG. 1.

FIGS. 6A and 6B show an embodiment of the present invention in which the Ubequity system 100 in FIG. 1 is used to reduce or eliminate change in a cash transaction by crediting at least part of the change to the customer deposit account 270.

In this embodiment, the communication device 260 may be a cell phone, and the merchant 210 may send instructions to the Ubequity change credit module 190 via a SMS (short message service) text message. To make it easier for the merchant 210 to send the SMS text message, the Ubequity operator may lease a CSC (common short code) which is a five-digit code for the merchant 210 to use instead of a ten-digit cellular telephone number to send the SMS text message. The customer deposit account 270 may be a cell phone bill of the customer 240.

Referring to FIG. 6A, the customer 240 pays the merchant 210 cash for an article or service (block 400), and requests that at least part of his change be credited to his customer deposit account 270 (in this embodiment, his cell phone bill), and provides his customer ID number 1307 to the merchant 210 (block 410).

The customer 240 may provide his customer ID number 1307 to the merchant 210 orally if, for example, his customer ID number 1307 is his cell phone number. If, for example, his customer ID number is his credit card number, the customer 240 may swipe his credit card through a card reader associated with the merchant terminal 250 himself, or he can hand the credit card to the merchant 210 so the merchant 210 can swipe the credit card through the card reader or can simply read the credit card number from the credit card.

The customer 240 may provide his customer ID number 1307 to the merchant 210 via a contactless sensor associated with the merchant terminal 250 or the communication device 260. For example, the customer 240 may have his customer ID number 1307 stored in a RFID (radio-frequency identification) tag embedded in his cell phone or in a key fob, or in an infrared device that communicates with the contactless sensor using infrared light, or in a proximity device that communicates with the contactless sensor in a contactless manner when the proximity device is placed near the contactless sensor, or in any other device that is capable of communicating with a contactless sensor.

The customer 240 may provide his customer ID number 1307 to the merchant 210 via a biometrics device associated with the merchant terminal 250 which may verify the identity of the customer 210 based on his fingerprints, a scan of his retina, or another suitable biometric identifier.

Although specific examples of how the customer 240 may provide his customer ID number 1307 to the merchant 210 have been given above, the present invention is not limited to these examples, but includes any method by which the customer 240 can provide his customer ID number 1307 to the merchant 210.

Referring again to FIG. 6A, the customer 240 may request that an amount of his change payable in coins be credited to his customer deposit account 270 (block 420). For example, if the cost of his purchase is $15.37 and the customer 240 pays with a $20.00 bill, his change is $4.63 and an amount of his change payable in coins is $0.63.

The customer 240 may request that an amount of his change payable in bills be credited to his customer deposit account 270 (block 430). In the above example in which his change is $4.63, an amount of his change payable in bills is $4.00.

The customer 240 may request that an arbitrary amount of his change selected by the customer 240 be credited to his customer deposit account 270 (block 440). In the above example in which his change is $4.63, the customer 240 may, for example, request that $2.63, or $2.00, or $3.50, or any other arbitrary amount be credited to his customer deposit account 270.

Finally, the customer 240 may request that an entire amount of his change be credited to his customer deposit account 270 (block 450). In the above example in which his change is $4.63, an entire amount of his change is $4.63.

The amount of his change that the customer 230 requests be credited to his customer deposit account 270 will be referred to below as the “change credit amount”.

The merchant 210 sends the change credit amount, the customer ID number 1307, and the merchant ID number 1407 to the Ubequity change credit module 190 in a SMS text message using a cell phone as the communication device 260 via the electronic medium 220, which in this example will include at least a wireless telephone network (block 460).

Referring to FIG. 5, the Ubequity change credit module 190 sets the merchant transaction amount 1605 to the change credit amount sent in the SMS text message, and calculates the Ubequity transaction fee 1606 and the customer transaction amount 1604 for the transaction based on the change credit amount (block 470). In the example discussed above in connection with FIG. 5, the change credit amount is $0.92 and the Ubequity transaction fee rate is 15% for an amount in excess of $0.05, and 50% for an amount of $0.05 or less, so the Ubequity change credit module 190 sets the merchant transaction amount 1605 to +$0.92 (“+” indicates a debit), calculates the Ubequity transaction fee 1606 as −$0.14 (15% of $0.92) (“−” indicates a credit), and calculates the customer transaction amount 1604 as −$0.78 ($0.92−$0.14) (“−” indicates a credit).

The Ubequity transaction fee 1606 may be calculated based on the entire change credit amount, or may be calculated based only on a portion of the change credit amount payable in coins as an incentive for the customer 240 to request that a greater portion of his change be credited to his customer deposit account 270. For example, assume a purchase of $5.08 paid for with a $10.00 bill resulting in change of $4.92, and the Ubequity transaction fee rate of 15% for an amount in excess of $0.05 and 50% for amount of $0.05 or less described above. If the customer 240 requests that an amount of his change payable in coins be credited to his customer deposit account 270, the change credit amount will be $0.92 and the Ubequity transaction fee 1606 will be $0.14 (15% of $0.92). If the customer 240 requests that an entire amount of his change be credited to his customer deposit account 270, the change credit amount will be $4.92 and the Ubequity transaction 1606 will be $0.74 (15% of $4.92) if it is based on the entire change credit amount, which might be high enough to discourage some customers from selecting this option. Accordingly, the Ubequity operator may elect to calculate the Ubequity transaction fee 1606 based only on a portion of the change credit amount payable in coins regardless of the portion of his change the customer 240 requests be credited to his customer deposit account 270. In this case, for the above example in which the change is $4.92 and the customer 240 requests that an entire amount of his change be credited to his customer deposit account 270, the change credit amount will be $4.92 but the Ubequity transaction fee will only be $0.14 (15% of $0.92, the portion of the change credit amount of $4.92 payable in coins). However, the present invention is not limited to these examples of the Ubequity transaction fee rate or structure, but may use any suitable rate and/or structure for the Ubequity transaction fee 1606.

The Ubequity change credit module 190 looks up the customer ID number 1307 sent in the SMS text message in the customer Ubequity account data 130 in the Ubequity database 120 and retrieves the deposit account type 1309 and the deposit account ID data 1310 of the customer deposit account 270 associated with the customer ID number 1307 (see FIG. 2) (block 480).

The Ubequity change credit module 190 looks up the merchant ID number 1407 sent in the SMS text message in the merchant Ubequity account data 140 in the Ubequity database 120 and retrieves the deposit account type 1409 and the deposit account ID data 1410 of the merchant account 280 associated with the merchant ID number 1407 (see FIG. 3) (block 490).

Referring to FIG. 6B, the Ubequity change credit module 190 retrieves the deposit account type 1503 and the deposit account ID data 1504 of the Ubequity operator deposit account 290 from the Ubequity operator Ubequity account data 150 in the Ubequity database 120 (see FIG. 4) (block 500).

The Ubequity change credit module 190 sends the customer transaction amount 1604, the merchant transaction amount 1605, the Ubequity transaction fee 1606, the deposit account type 1309 and the deposit account ID data 1310 of the customer deposit account 270, the deposit account type 1409 and the deposit account ID data 1410 of the merchant deposit account 280, and the deposit account type 1503 and the deposit account ID data 1504 of the Ubequity operator deposit account 290 to the electronic payment module 200 (block 510).

If the Ubequity server 110 hosts multiple electronic payment modules 200 to enable electronic payments to be made through multiple electronic payment systems 230, the Ubequity change credit module 190 sends the information described above to an appropriate one of the multiple electronic payment modules 200 based on the deposit account type 1309 of the customer deposit account 270, the deposit account type 1409 of the merchant deposit account 280, and the deposit account type 1503 of the Ubequity operator deposit account 290.

If the deposit account type 1309 of the customer deposit account 270 is not the customer Ubequity deposit account 300, the electronic payment module 200 instructs the electronic payment system 230 to debit the merchant transaction amount 1605 from the merchant deposit account 280, to credit the customer transaction amount 1604 to the customer deposit account 270 (for example, a cell phone bill), and to credit the Ubequity transaction fee 1606 to the Ubequity operator Ubequity deposit account 290 (block 520).

If the deposit account type 1309 of the customer deposit account 270 is the customer Ubequity deposit account 300, the electronic payment module instructs the electronic payment system 230 to debit the merchant transaction amount 1605 from the merchant deposit account 280, and to credit an amount equal to a sum of the customer transaction amount 1604 and the Ubequity transaction fee 1606 to the Ubequity operator Ubequity deposit account 290 (block 530).

The electronic payment system 230 makes the electronic payments as instructed by the electronic payment module 200, and notifies the electronic payment module 200 when the electronic payments are complete (block 540).

The electronic payment module 200 notifies the Ubequity change credit module 190 that the electronic payments are complete (block 550).

The Ubequity change credit module 190 stores the transaction details in the Ubequity transaction data 160 in the Ubequity database 120 (block 560).

More specifically, referring to FIG. 5, the Ubequity change credit module 190 assigns a unique transaction ID number 1601 to the transaction, sets the transaction date 1602 and the transaction time 1603, and stores the transaction ID number 1601, the transaction date 1602, the transaction time 1603, the customer ID number 1307, the customer transaction amount 1604, the merchant ID number 1407, the merchant transaction amount 1605, and the Ubequity transaction fee 1606 in the Ubequity transaction data 160 in the Ubequity database 120.

If the deposit account type 1309 of the customer deposit account 270 is the customer Ubequity deposit account 300, referring to FIG. 4, the Ubequity change credit module 190 updates the current balance 1506 of the customer Ubequity deposit account 300 associated with the customer ID number 1307 in the customer Ubequity deposit account subsidiary ledger data 1505 in the Ubequity operator Ubequity account data 150 in the Ubequity database 120 (block 570).

More specifically, the Ubequity change credit module 190 looks up the customer ID number 1307 in the customer Ubequity deposit account subsidiary ledger data 1505 in the Ubequity operator Ubequity account data 150 in the Ubequity database 120, retrieves the current balance 1506 associated with the customer ID number 1307, adds the customer transaction amount 1604 (see FIG. 5) to the current balance 1506 to obtain an updated current balance 1506, and stores the updated current balance 1506 in the customer Ubequity deposit account subsidiary ledger data 1505 in the Ubequity operator Ubequity account data 150.

The Ubequity change credit module 190 instructs the notification module 180 to send receipts for the electronic payments to the merchant 210 and the customer 240 (block 580).

More specifically, the Ubequity change credit module 190 sends the transaction ID number 1601, the transaction date 1602, the transaction time 1603, the merchant ID number 1407, the merchant transaction amount 1605, the customer ID number 1307, and the customer transaction amount 1604 to the notification module 180, and instructs the notification module 180 to send receipts for the electronic payments to the merchant 210 and the customer 240.

The notification module 180 sends receipts for the electronic payments to the merchant 210 and the customer 240 by email, for example (block 590).

More specifically, the notification module 180 may send a receipt for the electronic payment to the merchant 210 which may include the transaction ID number 1601, the transaction date 1602, the transaction time 1603, the merchant ID number 1407, and the merchant transaction amount 1605, and may send a receipt for the electronic payment to the customer 240 which may include the transaction ID number 1601, the transaction date 1602, the transaction time 1603, the customer ID number 1307, and the customer transaction amount 1604.

The PIN 1308 in the customer Ubequity account data 130 shown in FIG. 2 and the PIN 1408 in the merchant Ubequity account data 140 shown in FIG. 3 were not used in the process described above. However, the PIN 1308 and the PIN 1408 may be used in this process to authenticate the transaction and provide additional security for the transaction. Suitable methods for using PINs in transactions are well known in the art, and thus will not be further described here.

The process described above is a process for issuing a credit to the customer 240, so the merchant transaction amount 1605 was debited from the merchant deposit account 280, the customer transaction amount 1604 was credited to the customer deposit account 270, and the Ubequity transaction fee 1606 was credited to the Ubequity operator deposit account 290.

However, in another embodiment of the invention, the Ubequity system 100 shown in FIG. 1 may also be used to charge the customer 240 for a purchase of an article or a service. In this case, the customer transaction amount 1604 would be the purchase price and would be debited from the customer deposit account 270, the Ubequity transaction fee 1606 would be a certain portion of the purchase price set by an agreement between the Ubequity operator and the merchant 210 and would be credited to the Ubequity operator deposit account 290, and the merchant transaction amount 1605 would be the customer transaction amount 1604 less the Ubequity transaction fee 1606 and would be credited to the merchant deposit account 280.

In another embodiment of the invention, the customer 240 may elect to have the customer transaction amount 1604 rounded up an amount payable only in bills, with the difference between the rounded-up amount and the customer transaction amount 1604 being debited from his customer deposit account 270 and credited to a customer investment account. For the example of a $15.37 purchase paid for with a $20.00 bill described above, if the customer 240 has requested that an entire amount of his change of $4.63 be credited to his customer deposit account 270, the customer transaction amount 1604 will be $4.63 assuming there is no Ubequity transaction fee 1606. The customer transaction amount 1604 of $4.63 is credited to the customer deposit account 270 (for example, a cell phone bill of the customer 240). Then, this amount of $4.63 is rounded up to $5.00 (an amount payable only in bills), and the difference of $0.37 between the rounded-up amount of $5.00 and the customer transaction amount 1604 of $4.63 is debited from the customer deposit account 270 and credited to the customer investment account.

The customer investment account may be administered by the Ubequity operator, or by an outside investment firm retained by the Ubequity operator, in which case the Ubequity operator may decide to waive the Ubequity transaction fee 1606 in exchange for a commission on any money deposited into the customer investment account as an incentive for the customer 240 to use the Ubequity system 100.

Alternatively, the customer 240 may designate a customer investment account of his own choosing, in which case the Ubequity operator would charge the Ubequity transaction fee 1606, which would decrease the customer transaction amount 1604 by the amount of the Ubequity transaction fee 1606 compared to the above example in which it was assumed there was no Ubequity transaction fee 1606.

In another embodiment of the invention, the customer transaction amount 1604 may be credited to an account the customer 240 has with an existing loyalty program operated by an outside company instead of being credited to the customer deposit account 270. Alternatively, the Ubequity operator or a merchant may offer a new loyalty program as an incentive for the customer 240 to use the Ubequity system 100.

While the present invention has been particularly shown and described with reference to exemplary embodiments thereof, it will be understood by those of ordinary skill in the art that various changes in form and details may be made therein without departing from the spirit and scope of the present invention. For example, the present invention includes crediting an amount of change that is payable in coins to a buyer's account, crediting an amount of change that is payable in bills to the buyer's account, crediting an arbitrary portion of change specified by the buyer to the buyer's account, crediting an entire amount of change to the buyer's account, or debiting the buyer's account for a purchase or an article or a service. The present invention includes making electronic payments through one electronic payment system, or making payments through multiple electronic payment systems. If electronic payments are to be made through multiple electronic payment systems, the Ubequity server hosts multiple electronic payment modules each compatible with a respective one of the multiple electronic payment systems. The Ubequity server may be hosted on any suitable computer or data processing apparatus regardless of whether the computer or data processing apparatus is described as a “server” by its manufacturer. The various components hosted on the Ubequity server may be implemented using any suitable software. The merchant terminal may be a cash register or a POS (point-of-sale) terminal. The merchant terminal may be a virtual terminal running on any of the following: a server, a desktop computer, a laptop computer, a PDA (personal digital assistant), a WAP (wireless application protocol) phone, a cell phone, or any other suitable data processing apparatus. The virtual terminal may be web-based. The cash register, POS terminal, or virtual terminal may have the capability of processing payments made with money substitutes, such as, for example, checks, credit cards, debit cards, stored-value cards, and electronic money, or the merchant terminal may include a separate payment processing device for processing such payments, such as, for example, a credit card terminal or other device for processing such payments. The merchant may use the communication device directly or via the merchant terminal. The communication device may be any device which can communicate with the Ubequity change credit module over the electronic medium, such as, for example, a land-based telephone, a cell phone, a credit card terminal, a POS terminal, a virtual terminal, a desktop computer, a laptop computer, a PDA, a WAP phone, or any other suitable communication device. The communication device may be part of the merchant terminal. For example, if the merchant terminal includes a cash register, a POS terminal, a virtual terminal, or a credit card terminal and this device can communicate with the Ubequity change credit module over the electronic medium, then the cash register, the POS terminal, or the virtual terminal may be used as the communication device. The electronic medium over which the communication device communicates with the Ubequity change credit module such as, for example, a wired telephone network, a wireless telephone network, the Internet, an extranet, a WAN (wide-area network) a MAN (metropolitan area network), a VPN (virtual private network), a leased line, a wired non-telephone network, or a wireless non-telephone network, or any combination of two or more of these electronic media. The customer may create a Ubequity account by accessing the Ubequity website, or may call a Ubequity customer service agent who will create a Ubequity account for customer. The customer ID number or the merchant ID number may be, for example, a cell phone number of the customer or the merchant, a credit card number of the customer or the merchant, a debit card number of the customer or the merchant, an arbitrary character string which uniquely identifies the customer or the merchant, or any other number which uniquely identifies the customer or the merchant. The customer deposit account, the merchant deposit account, and the Ubequity operator deposit account may be, for example, a checking account or a savings account at a bank or other financial institution, a credit card account, a cell phone bill, a prepaid account, such as a prepaid cell phone account. The customer deposit account may also be a customer Ubequity deposit account. The transaction ID number may be, for example, a sequential number which is increased by one each time a transaction is conducted, or it may be a combination of the transaction date and the transaction time, or it may be derived based on any numbering scheme which produces a unique transaction ID number for each transaction. The electronic payment system may be any system capable of making electronic payments by electronically debiting one account and electronically crediting another account, such as, for example, the ACH (Automated Clearing House) network; or a credit card payment system, such as the Visa, MasterCard, American Express, Discover, and Diner's Club payment systems; or a payment system which enables a customer to pay for an article or service by calling a telephone number on his cell phone, such as the parking fee payment system operated by Verrus Mobile Technologies; or a payment system which enables a buyer to pay for an article or service by using his cell phone to initiate a payment process which debits the payment for the article or service from the buyer's bank account or from a prepaid cell phone account the buyer has with his wireless provider, and credits the payment to the merchant's account, such as the payment system developed by SEMOPS which may be modified to be able to credit an amount to the buyer's bank account, prepaid cell phone account, or cell phone bill, and to debit a payment for an article or service from the buyer's cell phone bill; or any other suitable electronic payment system known in the art. If the communication device is a cell phone, the merchant may send instructions to the Ubequity change credit module via a SMS (short message service) text message, which may be sent using a CSC (common short code) leased by the Ubequity operator. The customer may provide his customer ID number to the merchant orally if, for example, his customer ID number is his cell phone number. If, for example, his customer ID number is his credit card number, the customer may swipe his credit card through a card reader associated with the merchant terminal himself, or he can hand the credit card to the merchant so the merchant can swipe the credit card through the card reader or can simply read the credit card number from the credit card. The customer may provide his customer ID number to the merchant via a contactless sensor associated with the merchant terminal or the communication device. For example, the customer may have his customer ID number stored in a RFID (radio-frequency identification) tag embedded in his cell phone or in a key fob, or in an infrared device that communicates with the contactless sensor using infrared light, or in a proximity device that communicates with the contactless sensor in a contactless manner when the proximity device is placed near the contactless sensor; or in any other device that is capable of communicating with a contactless sensor, or the customer may provide his customer ID number to the merchant via a biometrics device associated with the merchant terminal or the communication device which may verify the identity of the customer based on his fingerprints, a scan of his retina, or another suitable biometric identifier; or the customer may provide his customer ID number to the merchant by any other suitable method. The Ubequity transaction fee may be calculated based on the entire change credit amount, or may be calculated based only on a portion of the change credit amount payable in coins, or may be calculated based on any other suitable Ubequity transaction fee rate and/or structure. Transactions conducted on the Ubequity system may use a customer PIN (personal identification number) and/or a merchant PIN to authenticate the transactions and provide additional security for the transactions. Accordingly, it is intended, therefore, that the present invention not be limited to the various example embodiments disclosed, but that the present invention includes all embodiments falling within the scope of the appended claims.

What is claimed is:

1. A method of reducing or eliminating change in a cash transaction, comprising:
receiving a cash payment for an article or a service from a buyer; and
crediting at least part of change from the cash payment due the buyer to an account of the buyer over an electronic medium.

2. The method of claim 1, wherein the crediting of the at least part of the change comprises crediting a maximum part of the change that can only be paid in coin to the buyer's account over the electronic medium.

3. The method of claim 1, wherein the crediting of the at least part of the change comprises crediting a maximum part of the change that can be paid only in paper money to the buyer's account over the electronic medium.

4. The method of claim 1, wherein the crediting of the at least part of the change comprises crediting an entire amount of the change to the buyer's account over the electronic medium.

5. The method of claim 1, wherein the crediting of the at least part of the change comprises:
asking the buyer to specify a part of the change the buyer wants credited to the buyer's account; and
crediting the part of the change specified by the buyer to the buyer's account over the electronic medium.

6. The method of claim 1, wherein the buyer's account is a savings account or a checking account.

7. The method of claim 1, wherein the buyer's account is a credit card bill.

8. The method of claim 1, wherein the buyer's account is a cell phone bill.

9. The method of claim 1, wherein the buyer's account is a prepaid account.

10. The method of claim 9, wherein the prepaid account is a prepaid cell phone account.

11. The method of claim 1, wherein the buyer's account is a virtual account maintained by a third party for the benefit of the buyer.

12. The method of claim 11, wherein the virtual account is held in an account belonging to the third party.

13. The method of claim 11, wherein the third party operates a system which enables the at least part of the change to be credited to the buyer's account over the electronic medium.

14. The method of claim 1, wherein the electronic medium comprises at least a wireless telephone network.

15. The method of claim 14, wherein the crediting of the at least part of the change comprises sending over the wireless telephone network an SMS text message specifying a part of the change to be credited to the buyer's account.

16. The method of claim 1, further comprising receiving a buyer ID number from the buyer via an RFID device, an infrared device, a proximity device, a smart card, or a key fob;
wherein the crediting of the at least part of the change comprises identifying the buyer's account based on the buyer ID number.

17. A system of reducing or eliminating change in a cash transaction, comprising:
a merchant terminal that processes a cash payment received from a buyer for an article or a service;
a communication device that sends a message over an electronic medium specifying that at least part of change from the cash payment is to be credited to an account of the buyer; and
a change credit apparatus that credits the at least part of the change to the buyer's account.

18. The system of claim 17, wherein the change credit apparatus comprises:
a change credit module that receives the message from the communication device and outputs a change credit amount equal to a part of the change that is to be credited to the buyer's account, a type of the buyer's account, and account ID data identifying the buyer's account;
an electronic payment module that receives the change credit amount, the type of the buyer's account, and the account ID data from the change credit module and outputs electronic payment instructions to credit the change credit amount to the buyer's account; and
an electronic payment system that receives the electronic payment instructions from the electronic payment module and credits the change credit amount to the buyer's account.

19. The system of claim 17, wherein the message specifies that a maximum part of the change that can only be paid in coin is to be credited to the buyer's account.

20. The system of claim 17, wherein the message specifies that a maximum part of the change that can be paid only in paper money is to be credited to the buyer's account.

21. The system of claim 17, wherein the message specifies that an entire amount of the change is to be credited to the buyer's account.

22. The system of claim 17, wherein the buyer specifies a part of the change the buyer wants credited to the buyer's account; and
wherein the message specifies that the part of the change specified by the buyer is to be credited to the buyer's account.

23. The system of claim 17, wherein the buyer's account is a savings account or a checking account.

24. The system of claim 17, wherein the buyer's account is a credit card bill.

25. The system of claim 17, wherein the buyer's account is a cell phone bill.

26. The system of claim 17, wherein the buyer's account is a prepaid account.

27. The system of claim 26, wherein the prepaid account is a prepaid cell phone account.

28. The system of claim 17, wherein the buyer's account is a virtual account maintained by a third party for the benefit of the buyer.

29. The system of claim 28, wherein the virtual account is held in an account belonging to the third party.

30. The system of claim 28, wherein the third party operates at least part of the change credit apparatus.

31. The system of claim 17, wherein the electronic medium comprises at least a wireless telephone network.

32. The system of claim 31, wherein communication device sends the message as an SMS text message over the wireless telephone network.

33. The system of claim 17, wherein the merchant terminal or the communication device receives a buyer ID number from an RFID device, an infrared device, a proximity device, a smart card, or a key fob; and
wherein the change credit apparatus identifies the buyer's account based on the buyer ID number.
